(19) United States
(12) Patent Application Publication
(10) Pub. No.: US 2019/0162849 A1
(43) Pub. Date: May 30, 2019

(54) HANDHELD SONAR APPARATUS

(71) Applicant: VODASAFE INC., Vancouver (CA)

(72) Inventors: Carlyn Loncaric, Vancouver (CA); David Degraaf, Vancouver (CA); Derek Solven, Coquitlam (CA); Juan Pablo Diaz Tellez, Vancouver (CA); Craig McLaughlin, Richmond (CA)

(73) Assignee: VODASAFE INC., Vancouver, BC (CA)

(21) Appl. No.: 16/320,991

(22) PCT Filed: Jul. 25, 2017
(86) PCT No.: PCT/CA2017/000180

§ 371 Date: Jan. 25, 2019

(51) Int. Cl. G01S 15/89; G01S 7/521; G01S 7/52

(52) U.S. Cl. CPC G01S 15/89; G01S 7/52085; G01S 7/52053; G01S 7/521

(57) ABSTRACT

A handheld device for manually scanning a body of water for the purpose of locating objects and persons therein. The present invention includes a waterproof housing with handle, a transducer, electrical and computer components within the housing for receiving and processing signals received from the transducer and a display to display the results of the processed signals. All located objects are displayed as symbols, providing a simple graphical representation of information indicating distance and location of any potential victims as well as other objects located within the area.

### BACKGROUND

Each year thousands of people die by drowning. According to the Centers for Disease Control and Prevention, in the United States alone, about ten people die from unintentional drowning each day. Moreover, two of these deaths will be children aged 14 or younger. In fact, drowning is the fifth leading cause of unintentional injury death for people of all ages, and the second leading cause of injury death for children ages 1 to 14 years.

One prior art method for rescue involves manual grid search diving whereby lifeguards will start at one location and dive down as far as possible, swim in one direction while searching for the victim, and then resurface for air. This is repeated in an attempt to cover as much area as possible. This method, however, is disadvantaged in that, while it can be relatively quick in time to begin, it is time consuming and prone to error, especially when water clarity is poor.

The prior art also discloses a side scan sonar device. This device must be towed or mounted to a boat or submarine for operation. It will obtain splices of the ocean floor directly beneath the vessel and stitch the images together to produce a photo-like image. However, this prior art device is limited in that it is very slow to deploy reducing the likelihood of rescue as well increases the search area due to water movement. Additionally, this device can only detect objects directly below the vessel and is limited in its ability to image in deep water or provide information on depth.

The prior art also discloses a multi-beam sonar device. This device includes an array of transducers that emit sound waves from the instrument. The sound reflections are then collected and interpreted by a computer to create a colored image showing the changes in depth of the ocean floor. This prior art device, however, is disadvantaged also due to it being slow to be deployed and being required to be mounted to a vessel. Additionally, it is relatively expensive to manufacture and operate.

Thus, there is a need for an improved sonar device that can be deployed in a relatively quick timeframe and be simple to use.

### BRIEF SUMMARY OF THE INVENTION

The present invention satisfies the needs discussed above. The present invention is generally directed toward a sonar device, and more specifically, toward a handheld sonar device that can be deployed in a relatively quick timeframe and be simple to use.

One general aspect of the present invention which is directed toward a handheld sonar device includes a waterproof housing with handle, a transducer, electrical and computer components within the housing for receiving and processing signals received from the transducer and a display to display the results of the processed signals.

Another aspect of the present invention is directed toward a hand held sonar device that can be used underwater, out of water, or partially submerged. This aspect includes having a housing with a handle, a data acquisition system (DAS), a microcomputer/data processing system (DPS), a display, an orientation cursor, a reorientation cursor, a data transmitter, a position correction system and a power source. The DPS may have an amplitude and frequency controller for adjusting the amplitude and frequency of signal based on temperature sensed, convert the acquired data to symbols based on acquired data, and display processed data on the display.

Further, an aspect of data acquisition system includes an activator (trigger) for activating the device that shoots sonar signals across a desired area, known as a field as the user sweeps the device across a 180 degree field (i.e. triangular, pie-shaped plane) and a transducer for converting electrical energy to acoustic energy, radiating sound pulse signals into the water along the field, and receiving the returned sound pulse signals. The transducer can be permanently attached to the housing or detachable so it can be placed in the water while the user stays in a boat.

This aspect of the data acquisition system further includes a receiver for filtering/amplifying the returned sound pulse signals. Once the sound energy is converted into electrical signals by the transducer, the signals are passed to a low noise amplifier followed by a variable gain amplifier. These signals are then passed to a converter for converting analog pulse signals to digital signals (ADC).

This aspect of the data acquisition system further includes a temperature sensor for measuring water temperature between an object and the device, and an amplitude controller for adjusting frequency of signal based on temperature sensed. The temperature sensor is utilized as sound travels at different speeds in different temperatures. Temperature will affect the speed of sound as well as the resistance of the water in which the sound travels, i.e. sound travels more quickly and with more ease in warmer water so the signal will take longer and suffer more degradation while traveling in colder waters. Based on the temperature of the water, the high voltage circuit will automatically adjust the strength of the signal sent from the transducer and the processor provides an adjustment of the calculated distance traveled by the return signal.

Overall, this aspect of the data acquisition system identifies objects within a desired field and determines the distance and direction from the device through the use of coordinates. The data is acquired from the transducer as an analog sine wave. The received signal passes through several stages of amplification before reaching an ADC, which converts the analog signal into a digital signal. Once digitized, the signal is then filtered using a 2-stage mathematical algorithm. Once filtered, the data is analyzed for intensity and time to determine density of the object and distance. In this aspect, a 2-stage algorithm is disclosed. Those skilled in the art will recognize this is for illustration. Other suitable algorithms will be within the scope of the invention.

An aspect of the microcomputer/data processing system (DPS) includes capabilities to digitally filter the input received from the data acquisition system and calculate results that are ultimately displayed. These capabilities further convert acquired data to symbols, such as distance and object type. The location printed on the screen will show distance and location, in combination with the live cursor to help the user with current orientation.

An aspect of the display includes the capability to display the results calculated by the DPS and to distinguish between different types of objects. The display can be of a liquid crystal display type or other similar type display. It is capable of being stationary, i.e. only displaying 180 degrees mapped, or having movable/scrollable capacity.

An aspect of the orienting cursor includes capabilities to determine in which direction objects are located. In an embodiment, the cursor acts like a compass needle in that it moves as the device is moved, but it does not show north. Instead it shows where in space the device was when the data was being recorded.

An aspect of the data transmitter (DT) includes the capability for sending data from the DPS to a monitoring station. This allows for communication between rescuers and dispatch for instance, and can be utilized through Bluetooth or Wi-Fi connections.

An aspect of the power source charger includes a docking station for charging similar to a cradle for a house phone that sits in a cradle continually charging. This allows for wireless charging.

An aspect of the position correction system includes the capability for data normalization, i.e. corrects data affected by device tilt/rotation when in use. This allows for automatic correction, as the user would not need to manually correct the system. In operation, it senses motion in the direction perpendicular to the desired field plane. It then filters out this “other” data allowing only change in motion to be about the axis of rotation up to 360 degrees along the field plane. This position correction system includes a sensor, an accelerometer, a gyroscope for providing angle info, and a magnetometer.

An aspect of the reorienting cursor includes the capability to reorient the device after the initial scan is completed, to show distance on the display screen which allows the user to switch between resolutions displayed, i.e. after an initial scan of distance of 50 m, the user can switch to scan of 20 m with higher resolution.

Another aspect of the present invention has two input capabilities, a capture or ‘trigger’ button and the resolution selection switch. When the trigger button is activated, the transducer begins acquiring data as the user scans the device under water across the region of interest. Data may be gathered for up to 360 degrees. The aspect of the present invention uses a single transducer as well as a motion sensor to interpret the transducer's location in space. As each data signal is received, the data is time stamped and recorded alongside the motion sensor's data at that moment in time creating a data set. Each data set is then used to interpret the signal's source and location. All data is displayed accordingly on the display and shows an object's location as well as the object's type. From this information, the user can make an accurate decision on where to begin their search. The resolution selection switch is used to adjust the resolution scans of the device.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1a is a front view of an embodiment of the present invention.

FIG. 1b is a photo of the front view of a prototype of an embodiment of the present invention.

FIG. 2 shows the back view of the prototype shown in FIG. 1b.

FIG. 3a is a top view of the embodiment of the present invention shown in FIG. 1b.

FIG. 3b is a top view of the prototype shown in FIG. 1a.

FIG. 4 is a bottom view of the prototype shown in FIG. 1b.

FIG. 5a is a left side view of the embodiment of the present invention shown in FIG. 1a.

FIG. 5b is a left side view of the prototype shown in FIG. 1b.

FIG. 6 is a right side view of the prototype shown in FIG. 1b.

FIG. 7a is an isometric view of the embodiment of the present invention shown in FIG. 1a.

FIG. 7b is an isometric view of the prototype shown in FIG. 1b.

FIG. 8 is a block diagram of an embodiment of the present invention.

FIG. 9 is a block diagram of an embodiment of a send and receive portion of an embodiment of a circuit design of the present invention.

FIG. 10 is a flow chart of an embodiment of a data acquisition and analysis process for transducer data of the present invention.

FIG. 11 is a data flow chart of an embodiment of an algorithm used for processing motion sensor data of the present invention.

FIGS. 12a and 12b are illustrative views of an embodiment of the display of the present invention.

FIG. 13 is a perspective view of an additional embodiment of the present invention.

### DETAILED DESCRIPTION AND BEST MODE OF IMPLEMENTATION

The present invention satisfies the needs discussed above. The present invention is generally directed toward a sonar device, and more specifically, toward a handheld sonar device that can be deployed in a relatively quick timeframe and be simple to use.

The Figures illustrate embodiments of the present invention. As shown in the Figures, an embodiment of the present invention comprises a waterproof housing with a handle, a data acquisition system attached to the waterproof housing, and a processor located within the waterproof housing. The data acquisition system may be configured to convert electrical energy to acoustic energy, radiate sound pulse signals into water along a field, and receive the returned sound pulse signals. Further, the data acquisition system may include an activator configured to activate the device and a transducer. The activator may be in a trigger configuration. The transducer may be detachably attached to the waterproof housing. The processor may include an amplitude and frequency controller. Further, the processor may be configured to adjust the amplitude and frequency of the returned sound pulse signals, as well as may be configured to convert acquired data to symbols based on acquired data.

This embodiment may further include a temperature sensor for measuring water temperature. The processor is configured to adjust the amplitude and frequency of the returned sound pulse signal based on temperature sensed.

This embodiment may further include at least one of the following: location cursor for orienting the device and determining in which direction objects are located, a scrollable display, a data transmitter for sending data from the processor to a monitoring station, and a converter for converting analog pulse signals to digital signals and a reorienting cursor being displayed on the display for reorienting the device after initial call and allowing a user to switch between distances/resolutions viewed.

This embodiment may further include a position correction system that may be configured to normalize data affected by device tilt/rotation operation. The position correction system may also be configured to sense motion, as well as may be configured to discard non-material data allowing a change in motion to be about an axis of rotation up to 360 degrees along a field plane. The position correction system may include a sensor, an accelerometer, a gyroscope, a magnetometer, and a compass.

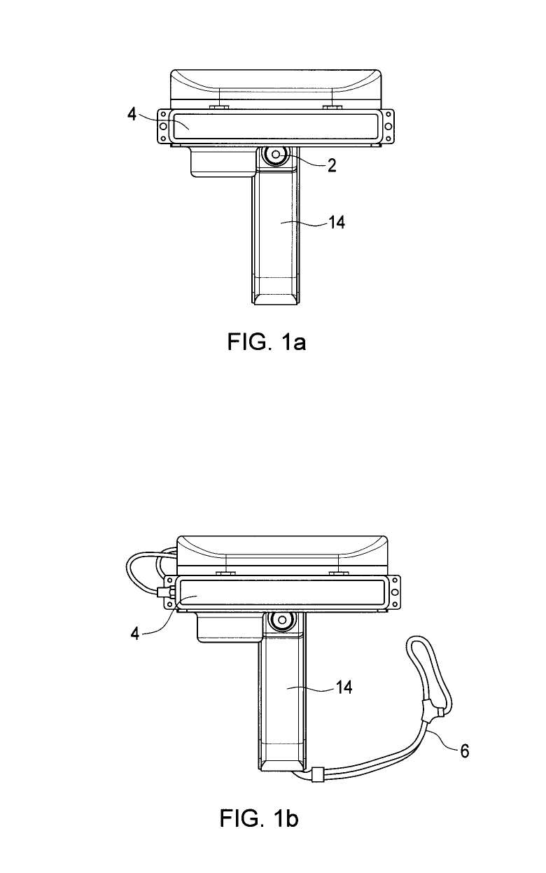

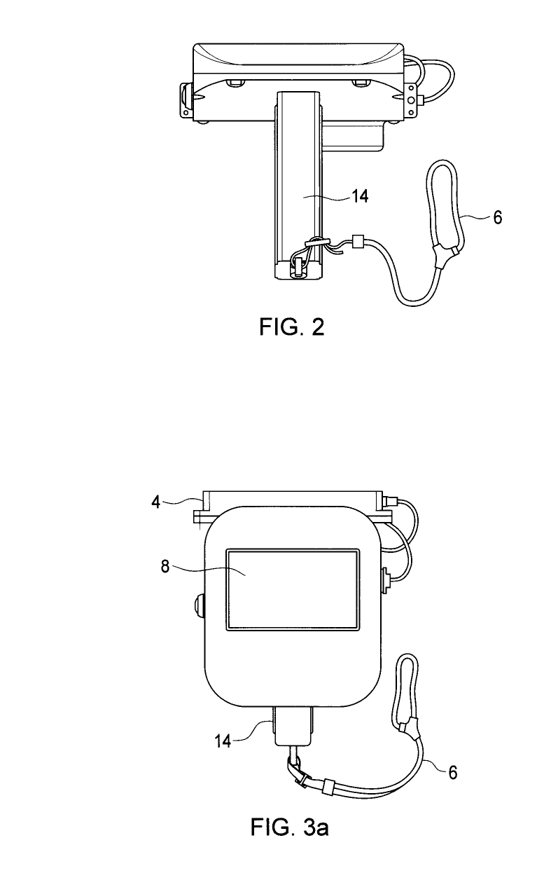

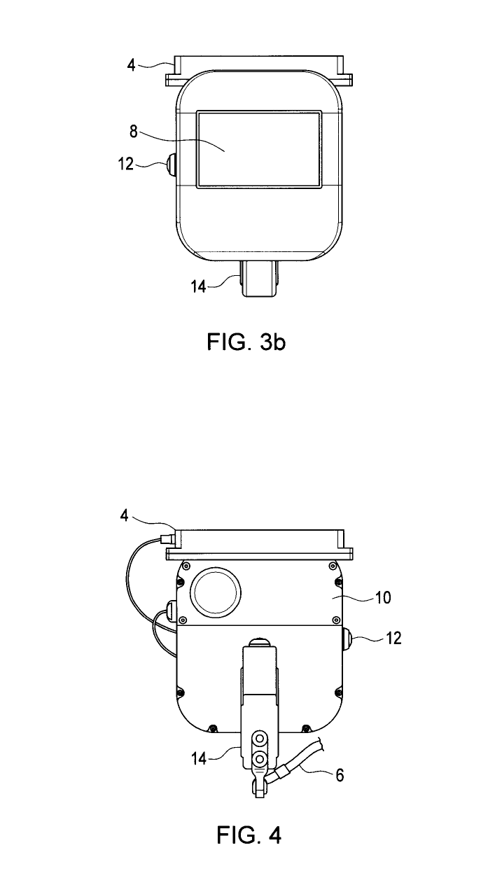

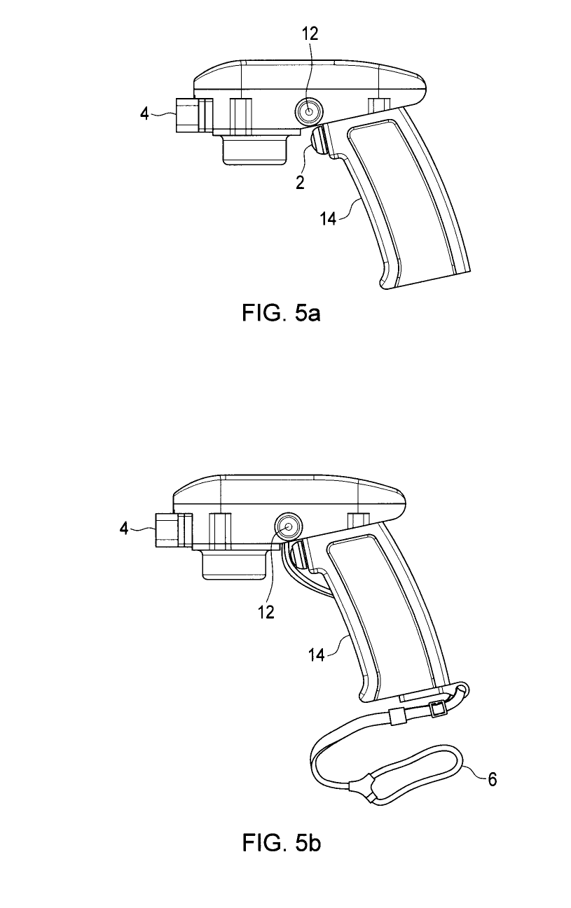

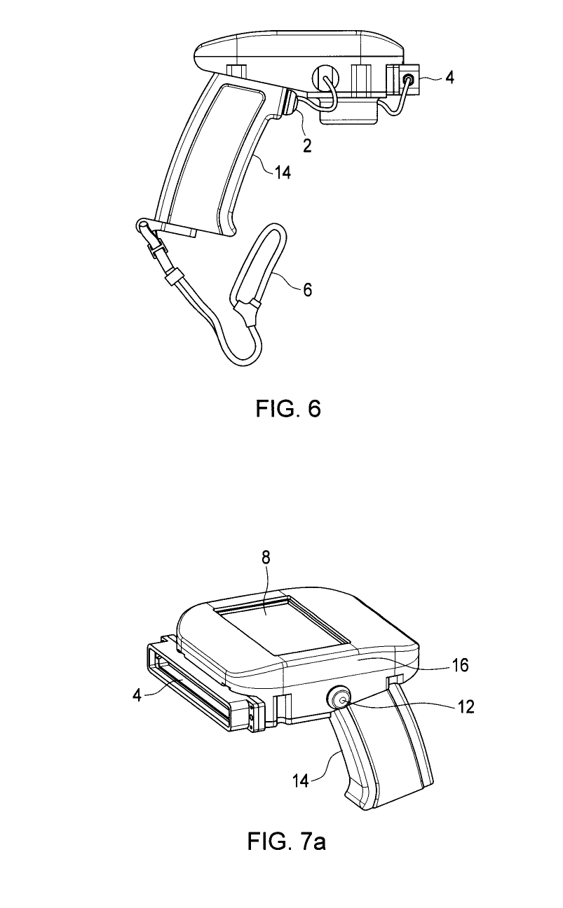

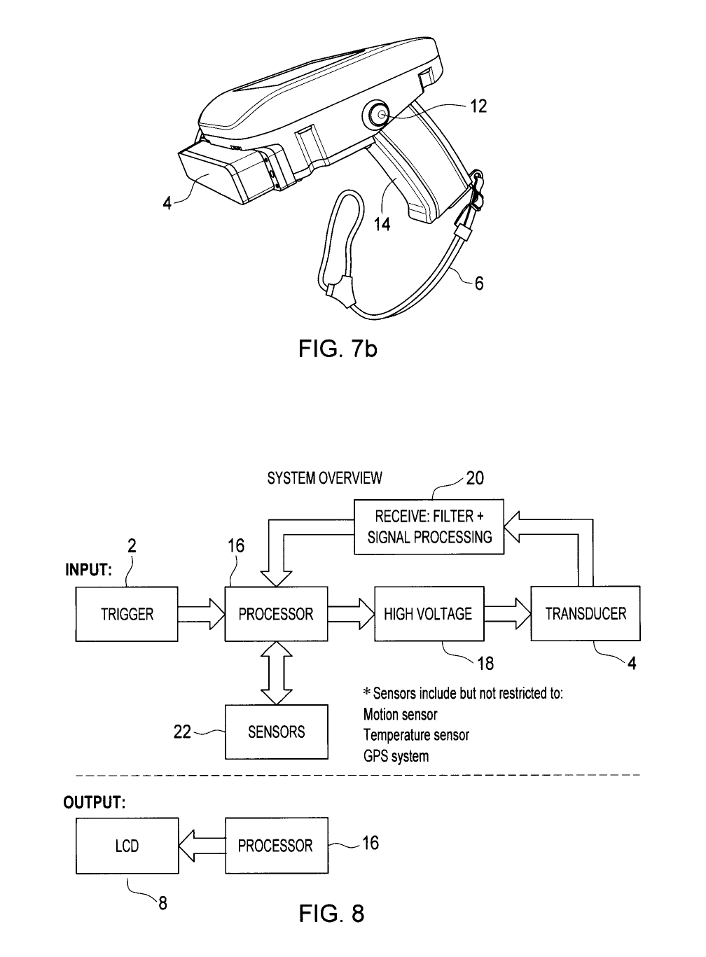

An embodiment of the present invention comprises a trigger button 2 located on the handle 14 and a single fan beam transducer 4. The wrist strap 6 is shown in FIG. 1b. The liquid crystal display (LCD) 8 is shown in FIGS. 3a and 3b, and the battery storage compartment 10 is shown in FIG. 4. The power button 12 can be seen in FIGS. 5a and 5b. FIG. 7a shows the ergonomic design of the handle 14 to allow for single hand operation, as well as the tilt 16 of the LCD 8 for easier viewing.

FIG. 8 illustrates an overview of the embodiment's hardware design. Upon receiving input from the trigger button 2, the processor 16 begins a scanning algorithm. Data is acquired from the sensors 22 and interpreted by the processor, while the transducer 4 is activated by the high voltage circuit 18. The return signals register on the transducer 4 and are processed by the receive circuit 20. Once processed, the scan results are then output and displayed on the LCD 8.

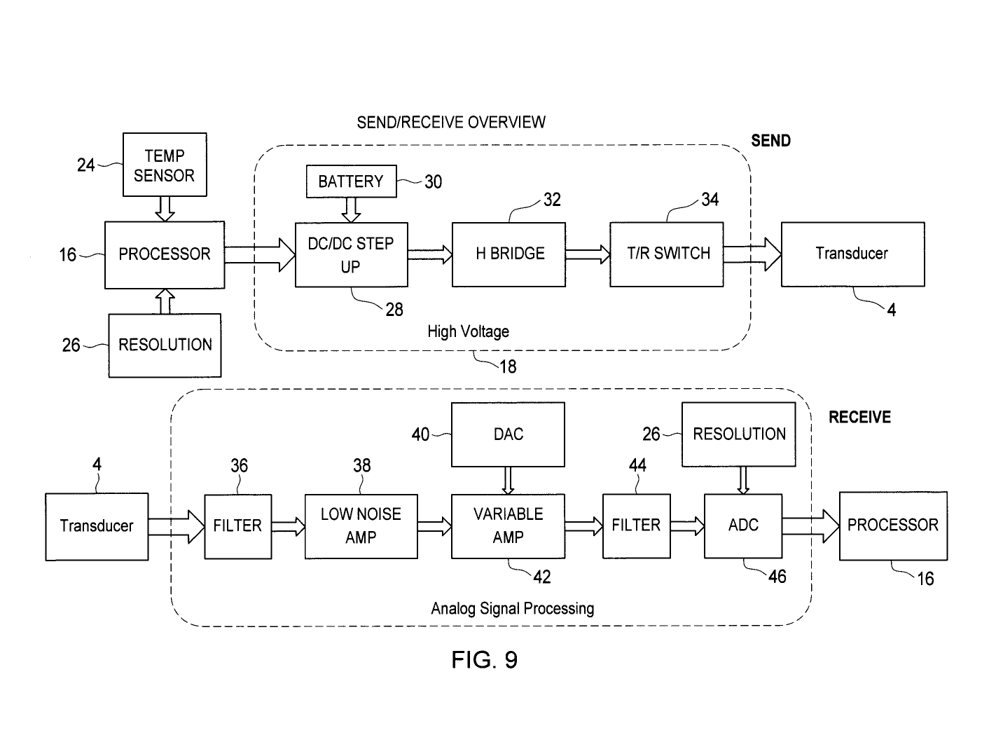

FIG. 9 shows a more detailed view of an embodiment of the send and receive analog circuit design which consists of the high voltage circuit 18 and the analog receive circuit 20. The high voltage circuit 18 is controlled by the processor 16, which interprets the temperature sensor 24 and resolution selection inputs 26, and adjusts the high voltage circuit 18 output accordingly. The DC/DC voltage converter 28 is a high voltage source powered from the input voltage supplied by the battery 30. The output of the DC/DC voltage converter is used to generate the high voltage switching signal produced by the H-bridge 32.

The analog receive circuit 20 comprises: the transducer 4, the processor 16, a low pass filter 36, a low noise amplifier (LNA) 38, a variable gain amplifier (VGA) 42, a digital to analog converter (DAC), and an analog to digital converter (ADC) 46. To begin operation, the transducer 4 must be “excited” by a high voltage pulse signal. The amplitude of the pulse signal will be determined by the processor 16 upon receiving temperature data, as well as user input from the resolution selector switch. These two pieces of data will then set the amplitude of the pulse signal and the duration of return pulse analysis. In an embodiment, the resolution determines how long incoming data is recorded for and how it is displayed. In an embodiment, it may affect amplitude. When the trigger button 2 is actuated, a pulse train will be sent to the transducer 4 by way of a high voltage DC/DC converter 28 and the H-bridge (i.e. acting as the switch) 32. Once the signal is sent to the transducer 4, the transducer 4 will vibrate or pulse, emitting a sound wave into its surrounding medium.

After the pulse train completes, the transducer 4 will continue to vibrate for a short period of time, creating noise or ‘ringing’ on the transducer receive circuit 20. The processor 18 accounts for this noise and only processes potential object data. The receive circuitry works as follows: once the return signal reaches the transducer 4, its mechanical energy is converted into electrical energy. This electronic signal then enters the receive circuit 20 and is filtered by a low pass filter 36 that will eliminate any high frequency signals. The signal is then amplified by the LNA 38, further reducing noise and increasing the signal's amplitude. The LNA 38 produces a differential output signal which is then input to the VGA 42. The gain of the VGA 42 is set by the DAC 40 and determined by the amount of time passed since the pulse signal was sent to the transducer 4. Once the signal exits the VGA 42, it is filtered again by a low pass filter 44 to remove any frequencies above that of the desired operating frequency. The signal then reaches the ADC 46, where it is converted into a digital signal and passed to the processor 16. The amount of time that the processor 16 will continue to record data is determined by the user's input selection of resolution. In an embodiment, the higher the resolution, the shorter the recording time. Once the data is received by the processor 16, data processing begins. In an embodiment, there may be more than one stage of VGA. More stages of filtering and amplification may be desirable.

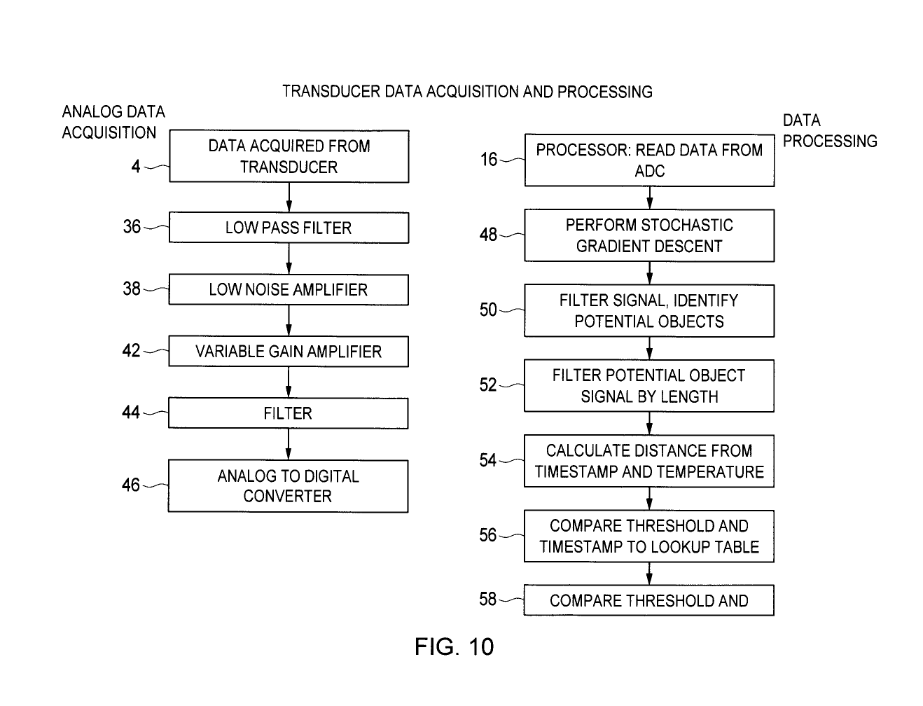

FIG. 10 illustrates an embodiment of the data acquisition and processing algorithm. When the ADC 46 stops outputting data, data processing begins. In an embodiment, first, a Stochastic gradient descent may be performed on the data to identify any noise signals interfering with potential object data, however alternative different methods of analysis may be used. The result is then filtered to remove any noise signals from the data, while any potential object data points are flagged and saved for further processing. The final filter determines whether the detected data points are in fact an object by filtering the data by pulse length. Distance is calculated by finding the data point's associated time stamp and converting to distance based on the speed of sound in water, adjusted to the temperature of the water. The type of object is determined by comparing the density and distance calculated for the current data set to the look up table data set. Alternatively, the data processing may occur in real time and be continuously read without the ADC 46 stopping.

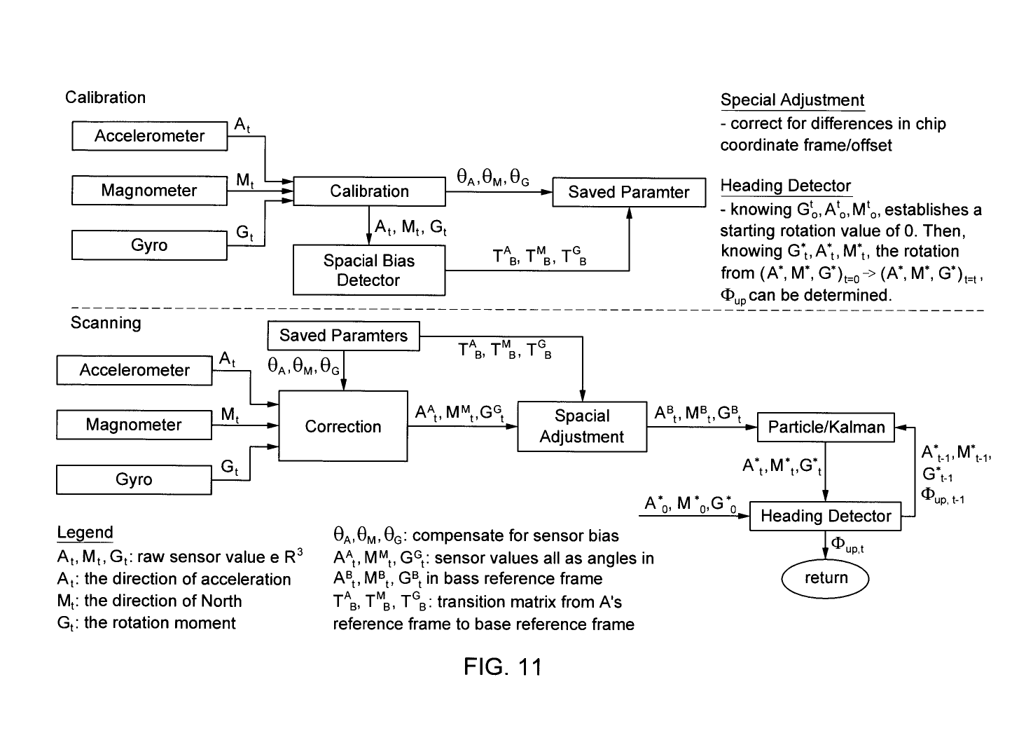

Once the object's distance and type has been determined the object's location must be resolved. The location is determined by interpreting the motion sensor's data and calculating the current location relative to the position at which the scan commenced. As the present invention is used, the user's hand will likely fluctuate in axes other than that of rotation. To ensure motion data is not misrepresented, the motion sensor algorithm tracks changes in all 3 axes, and determines whether motion is occurring about the axis of rotation or not. The motion data is adjusted in the case where changes occurring in the axis of rotation are below a certain threshold while changes in the other axes are above a certain threshold. The algorithm used to monitor positional changes and adjust current rotation values is shown in FIG. 11.

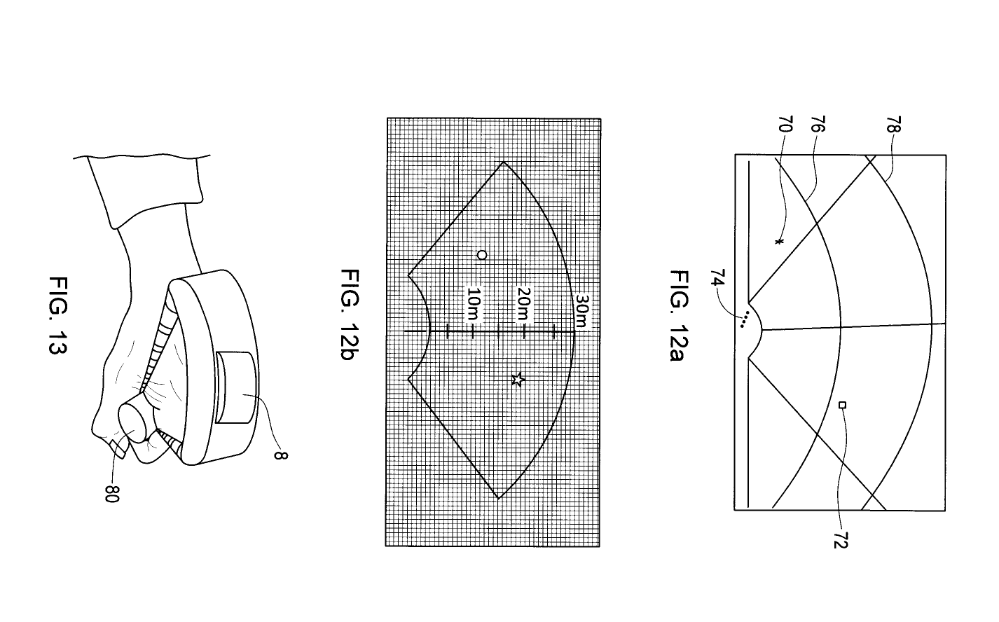

FIG. 12 shows an embodiment of the LCD 8 depicting 2different types of objects found, a cursor 74 to indicate current direction, and 2arcs depicting 10 76 and 20 78 meters from the user. The LCD 8 displays as many different object types as are located, and depicts each type in a different color and symbol. It also displays hash marks every 5 meters that adjust according to resolution. In another form of the invention, the cursor is implemented to cross the entire screen instead of occupying the 50×50 pixels as shown in FIG. 12. Once the data has been committed to the LCD 8, the view does not change—the LCD 8 shows a 180 degree view. In another form of the invention a moving display is implemented. The user scans a 360 degree view, all data is saved to memory, and then 180 degrees of that data is depicted at one time on the LCD 8. In this implementation, as the user rotates the present invention across 360 degrees, the LCD 8 continually updates, showing the 180 degrees of data centered about the user's current location. FIG. 12b illustrates an exemplary display where a user sweeps the device from left to right, say over 160 degrees, and then 2 objects are shown on the screen, around 30 degrees and 90 degrees after the start position. The user cannot be expected to remember where exactly they started the sweep and figure out where to swim to reach the objects. But the cursor at the bottom shows the user is currently holding the device at exactly half way through the sweep they just completed. So, as the device is moved back along the sweep trace, the needle will move. Once the needle lines up with the object on the screen, the user will know the device is now pointing in the direction of the object. If the user does not scan a full 180 degrees, the unscanned portion (illustrated in FIG. 12b) may be greyed out (not shown) so the user is aware that no data was collected in the un-scanned region.

In another embodiment of the invention, continuous scanning is implemented meaning the transducer data is acquired and processed in real time, and the LCD 8 is updated live as the user scans. Old data is continually over written with new data until the trigger button 2 is released.

In additional embodiments of the present invention, broadband sonar transmission could be used to obtain frequency spectral data, and possibly enhance object detection and identification. Further, the present invention can be compatible with a tablet, PC or smartphone, where by the output data is displayed wirelessly to the LCD of the selected device. Still further, the resolution selector switch can be located on either the left or the right side of the device, or on the top of the device, somewhere it is easily accessible.

In an embodiment of the present invention, a temperature sensor 24 reports water temperature to the processor. Because sound travels at different speeds in different water temperatures, the water temperature affects the required signal strength of the pulse signal sent to the transducer, as well as the calculation used to determine the distance the signal has traveled based on time.

In an embodiment of the present invention, power can be supplied from a 4 cell lithium ion battery pack 30. The prototype battery 30 is charged using a multi-purpose battery charger. Those skilled in the art will understand that this is illustrative and other forms of power are within the scope of the present invention, including being designed to be charged wirelessly. A separate charging dock, similar to that of an electric toothbrush dock, can recharge battery pack 30 wirelessly. Additional embodiments include utilizing different power management such as a lower voltage source coupled with a boost converter, a different battery technology, or using an alternate power source such as solar energy to recharge the batteries.

In this embodiment, buttons 2, 12, are IP67 Dust Tight, Waterproof rated push buttons. Other embodiments can include higher IP graded buttons and Hall effect buttons.

In another embodiment of the present invention, the resolution selector is a dial or slider switch. The dial or slide would allow the resolution to be increased or decreased to the user's preference rather than a minimum and maximum resolution option.

In another embodiment of the present invention, the trigger is not activated by a button, but instead, by a motion of the user's hand. For instance, shaking the device similar to a hand shake gesture, or by quickly rotating the device by a wrist rotation or wrist flick.

In another embodiment of the present invention, a GPS system allows the user's location to be tracked by GPS and recorded for later review. Data is transferred wirelessly or through Bluetooth to a data system for collection and analysis. A GPS signal allows the user to be tracked in real time while they are performing a search. If several inventive handheld sonar devices were being used at one time, GPS signals of all rescuers are displayed to the LCD 8 to inform rescuers of their team's location. Again, all this data could be transferred wirelessly to an on shore server where the rescue team is being observed and tracked for their safety.

In another embodiment of the present invention, a calibration system can be integrated into the design. The user could select the option to calibrate the device, perform a scan, and the data would be analyzed and saved as the ambient noise signal level. The ambient signal result would then be used to filter incoming signals during subsequent scans to detect objects with higher accuracy. A particular scanning pattern or even a series of point and shoot scans could also be used to collect data for calibration.

In another embodiment of the present invention, the housing is optimized for shape and weight. The battery storage compartment 10 may be stored in the handle 14 or another location to allow for a more ergonomic design. Further, different materials can be used to allow the present invention to withstand pressure changes and can be designed to be waterproof up to 30 meters or more for scuba diving or other underwater activities. Still further, an embodiment of the housing is designed for buoyancy to maintain neutral buoyancy while in use at different water depths.

In another embodiment of the present invention, a wrist strap 6 connected to the handle 14 provides assurance that even if the user were to release the present invention, it would not fall. Buoyancy design will prevent the device from sinking while in the water, but the wrist strap 6 provides security on land as well as ensures the present invention does not float far from the user if released while under water. A cross chest strap could also be implemented, similar to those used for SLR cameras, to allow the user to have access to the present invention without holding it at all times.

In another embodiment of the present invention, the transducer is detachable and allows the user to either hold the transducer by hand, or have the transducer connected to a pole or similar. This allows the user to sit in a boat and extend the transducer into the water while watching the LCD 8 in the boat. It is also possible for a user to put the transducer under ice through an access hole while staying safely above the ice.

In another embodiment of the present invention, the housing is optimized for swimming In this embodiment, the device no longer has a vertical handle 14; instead it straps to the users hand and rests on top of the back of their hand as shown in FIG. 13. The device is activated by the squeezing motion of the user's hand around the horizontal handle 80.

In another embodiment of the present invention, a wrist strap receiver is used to communicate with the components located within the housing. This version is useful for tracking scuba divers or swimmers, for instance during training. The wrist strap or watch is designed to vibrate and/or illuminate at a specified frequency, which can be the same frequency the present invention emits. The present invention then is capable of displaying the location of all users wearing a wrist strap or watch.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

What is claimed:

1. A device for sensing the location of an object underwater, the device comprising:
a waterproof housing with a handle;
a data acquisition system attached to the waterproof housing; and
a processor located within the waterproof housing, the processor comprising an amplitude and frequency controller.

2. The device of claim 1, wherein the data acquisition system is configured to convert electrical energy to acoustic energy, radiate sound pulse signals into water along a field, and receive the returned sound pulse signals.

3. The device of claim 1, wherein the data acquisition system comprises an activator configured to activate the device and a transducer.

4. The device of claim 3, wherein the activator comprises a trigger configuration.

5. The device of claim 3, wherein the transducer is detachably attached to the waterproof housing.

6. The device of claim 1, wherein the processor is further configured to adjust the amplitude and frequency of the returned sound pulse signals.

7. The device of claim 1, wherein the processor is further configured to convert acquired data to symbols based on acquired data.

8. The device of claim 1, further comprising:
a temperature sensor for measuring water temperature,
wherein the processor is configured to adjust the amplitude and frequency of the returned sound pulse signal based on temperature sensed.

9. The device of claim 1, further comprising:
a location cursor for orienting the device and determining in which direction objects are located.

10. The device of claim 1, further comprising:
a scrollable display,
wherein the processor is configured to display processed data on the scrollable display.

11. The device of claim 1, further comprising:
a data transmitter for sending data from the processor to a monitoring station.

12. The device of claim 1, further comprising:
a converter for converting analog pulse signals to digital signals.

13. The device of claim 1, further comprising:
a position correction system configured to normalize data affected by device tilt/rotation operation.

14. The device of claim 13, wherein the position correction system further configured to sense motion.

15. The device of claim 14, wherein the position correction system further configured to discard non-material data allowing a change in motion to be about an axis of rotation up to 360 degrees along a field plane.

16. The device of claim 13, wherein the position correction system comprising a sensor, an accelerometer, a gyroscope, a magnetometer, and a compass.

17. The device of claim 1, further comprising:
a reorienting cursor being displayed on the display for reorienting the device after initial call and allowing a user to switch between distances/resolutions viewed.

18. A device for sensing the location of an object underwater, the device comprising:
a waterproof housing with a handle;
a transducer located within the waterproof housing, the transducer configured to convert electrical energy to acoustic energy, radiate sound pulse signals into the water along a field, and receive the returned sound pulse signals;
a processor located within the waterproof housing, the processor comprising an amplitude and frequency controller; and
a position correction system configured to normalize data affected by device tilt/rotation operation, to sense motion, and to discard non-material data allowing a change in motion to be about an axis of rotation up to 360 degrees along a field plane.

19. The device of claim 18, wherein the position correction system comprises a sensor, an accelerometer, a gyroscope, and a magnetometer.

20. The device of claim 18, further comprising:
a reorienting cursor being displayed on the display for reorienting the device after initial call and allowing a user to switch between distances/resolutions viewed.
